(19) United States
(12) Patent Application Publication
(10) Pub. No.: US 2007/0201338 A1
(43) Pub. Date: Aug. 30, 2007

(54) OPTICAL DISC RECORDING APPARATUS, CONTROLLING METHOD OF THE SAME, AND OPTICAL DISC

(75) Inventors: Akiko Yaoita, Kanagawa-ken (JP); Shinichi Tatsuta, Tokyo (JP); Akiko Hirao, Chiba-ken (JP); Kazuki Matsumoto, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/680,301

(22) Filed: Feb. 28, 2007

(30) Foreign Application Priority Data
Feb. 28, 2006 (JP) 2006-053599

(51) Int. Cl. G11B 7/00

(52) U.S. Cl. 369/103

(57) ABSTRACT

An optical disk recording apparatus and method utilize a recording beam source, a spatial light modulator that modulates a recording radiation beam into an information beam carrying information and a reference beam, a focusing unit that focuses the information beam and the reference beam onto an information recording layer, an image sensing device that detects intensity distribution of the information beam, and a control unit. The control unit controls the spatial light modulator on the basis of the intensity distribution detected by the image sensing device. An optical disk recording apparatus, and a control method thereof, thereby has a high signal-to-noise ratio.

### CROSS-REFERENCE TO RELATED APPLICATIONS

This application is based upon and claims the benefit of priority from the prior Japanese Patent Application No. 2006-053599, filed Feb. 28, 2006, the entire contents of which are incorporated herein by reference.

### BACKGROUND OF THE INVENTION

1. Field of the Invention

The present invention relates to an optical disk recording apparatus for recording information as a hologram on an optical disk, a method of controlling the optical disk recording apparatus, and an optical disk.

2. Description of the Background Art

Recently, a high-density optical disc of a volume recording type using a hologram (hereinafter, referred to as “a holographic optical disc”) and a recording/reproducing apparatus for a holographic optical disc have been developed to be put into practical use. A holographic optical disc recording method is a method of recording information by making an information beam carrying an image and a reference beam for recording interfere with each other in a photosensitive material, and collectively recording a two-dimensional image having been digitally encoded by a spatial light modulator, such as a liquid crystal element or a digital micro-mirror device. Information is three-dimensionally recordable in a thickness direction of an information recording layer and it is possible to multiply record the information at the same position or at an overlapping position of an information recording layer. Therefore, it is possible to remarkably increase the recording capacity, as compared to a current recording method of performing recording in a plane surface represented by an HD DVD. Further, since it is possible to read information in the units of two-dimensional images when the information is reproduced, it is possible to obtain a high information transfer speed.

Various techniques related to a recording/producing apparatus for a holographic optical disc have been developed. Among those techniques, a collinear hologram recording method coaxially disposing an information beam and a reference beam is, as a succession of a recording/reproducing apparatus for an optical disc, such as an HD DVD or a Blu-ray disc, in the spotlight.

The techniques using the collinear hologram recording method are disclosed in, for example, “Advanced Collinear Holography”, Optical Review, Vol. 12, No. 2, 90-92 (2005), and “A Novel Collinear Optical Setup for Holographic Data Storage System”, Proceedings of SPIE of Optical Data Storage 2004, pp. 297-303 (2004), and JPA (Kokai) 2004-265472. In the collinear hologram recording method, intensity modulation is performed on a green or blue-violet laser beam emitted from a laser for recording/reproducing by a spatial light modulator so as to generate an information beam and a reference beam, which are focused on an information recording layer of an optical disk by an object lens. Then, an interference fringe pattern is generated by making the information beam and the reference beam interfere with each other in the information recording layer and is fixed in the information recording layer. As a result, information is recorded as a hologram.

In the collinear hologram recording method, the information beam and the reference beam for recording generated from the recording/reproducing laser pass through a dichroic mirror and are radiated onto an optical disk by the object lens so as to generate an interference pattern in a hologram recording layer.

Meanwhile, when information is recorded on a holographic optical disc, the intensity distribution of a light beam generated by a recording/reproducing laser in the diametric direction generally obeys Gaussian distribution as disclosed in JPA (Kokai) 2005-195767. Also, there have been proposed a technique for making the intensity distribution uniform and a technique for forming a grayscale cell state using apodization by exposure time division of the spatial light modulator when information is recorded using a light beam having such intensity distribution.

In the recording/reproducing apparatus for a holographic optical disc, when the intensity distribution of the light beam generated by a laser for recording/reproducing in the diametric direction does not obey Gaussian distribution, when there is an individual difference in the recording/reproducing semiconductor laser, or when there is an assembly variation of the optical system including the recording/reproducing semiconductor laser or the object lens, it is difficult to make the intensity distribution uniform.

When the information beam and the reference beam interfere with each other, the intensity distribution of the light beam generated by the recording/reproducing semiconductor laser in the diametric direction affects interference contrast. Therefore, when the uniformizing of the intensity distribution is not sufficiently performed, irregularity occurs in the interference contrast and thus a signal-to-noise ratio is reduced.

### SUMMARY OF THE INVENTION

It is an object of the invention to provide an optical disk recording apparatus having a high signal-to-noise ratio and a controlling method thereof.

According to an aspect of the invention, an optical disc recording apparatus includes: a recording beam source that emits a recording radiation beam; a spatial light modulator that modulates the recording radiation beam to an information beam and a reference beam; a focusing unit that focuses the recording radiation beam, the reference beam, or the information beam and the reference beam on an information recording layer; an image sensing device that detects the optical intensity distribution of the recording radiation beam or the information beam; and a control unit that controls the spatial light modulator. The optical disc recording apparatus can record information as a hologram on the information recording layer by interference fringes generated by the interference between the information beam carrying the information and the reference beam. Further, the control unit obtains a value representing an integrated intensity distribution detected by the image sensing device across at least some of a plurality of pixels, and controls the spatial light modulator such that information related to the values is carried by the information beam.

According to another aspect of the invention, a controlling method of an optical disc recording apparatus includes changing a value representing an integrated intensity distribution across at least some of a plurality of pixels carried by an information beam and to be radiated to an information recording layer. In the controlling method, the optical disc recording apparatus can record the information as a hologram on the information recording layer formed in an optical disk by interference fringes generated by the interference of the information beam carrying the information and the reference beam.

Further, the optical disc recording apparatus includes: a recording beam source that emits a recording radiation beam; a spatial light modulator that modulates the recording radiation beam into the information beam and the reference beam; a focusing unit that focuses the recording radiation beam, the reference beam, or the information beam and the reference beam on an information recording layer; and an image sensing device that detects the optical intensity distribution of the recording irradiation beam or the information beam.

### BRIEF DESCRIPTION OF THE DRAWINGS

A more complete appreciation of the present invention, and many of the attendant advantages thereof, will be more readily obtained as the same becomes better understood by reference to the following figures in which:

FIG. 1 is a cross-sectional view illustrating a holographic optical disc according to a first embodiment of the invention;

FIG. 2 is a view illustrating an optical system of an optical disc recording/reproducing apparatus according to the first embodiment;

FIG. 3 is a view illustrating a modulation pattern of a reference beam and an information beam according to the first embodiment;

FIG. 4 is a view illustrating a control system of the optical disc recording/reproducing apparatus according to the first embodiment;

FIG. 5 is a view illustrating a method of controlling the optical disc recording/reproducing apparatus according to the first embodiment;

FIG. 6 is a view illustrating the distribution of power density of the optical disc recording/reproducing apparatus according to the first embodiment;

FIG. 7 is a view illustrating a holographic optical disc according to a second embodiment of the invention;

FIG. 8 is a view illustrating a method of controlling an optical disc recording/reproducing apparatus according to the second embodiment;

FIG. 9 is a view illustrating the distribution of power density of the optical disc recording/reproducing apparatus according to the second embodiment;

FIG. 10 is a view illustrating a modification of an optical disc recording/reproducing apparatus according to another embodiment of the invention; and

FIG. 11 is a view illustrating another modification of an optical disc recording/reproducing apparatus according to another embodiment of the invention.

### DETAILED DESCRIPTION OF THE PREFERRED EMBODIMENTS

Hereinafter, an optical disc recording apparatus, an optical disc recording method, and an optical disk used therefor according to preferred embodiments of the invention will be described with reference to the accompanying drawings.

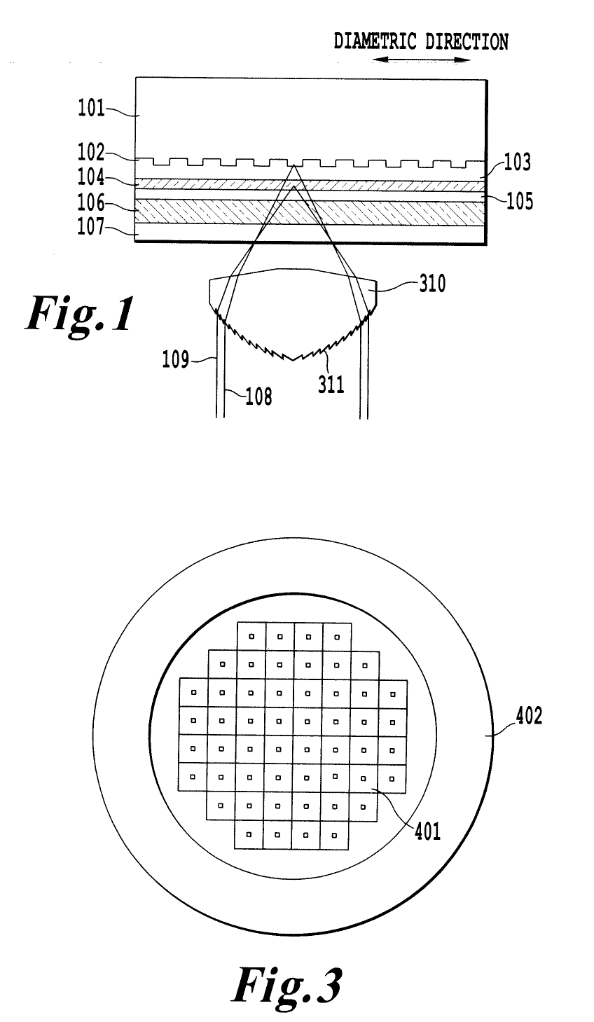

First, a holographic optical disc, which is an optical disk according to a first embodiment of the invention, will be described. A holographic optical disc is a disc capable of recording, as a hologram, an interference fringe pattern of alternating bright and dark bands generated by the interference between an information beam and a reference beam. FIG. 1 is a cross-sectional view of the holographic optical disc according to the first embodiment As shown in FIG. 1, the holographic optical disc according to the first embodiment has a structure in which a transparent gap layer 103, a dichroic mirror layer 104, a transparent gap layer 105, a hologram recording medium layer 106 serving as an information recording layer, and a protective layer 107 are sequentially laminated on a substrate 101 made of polycarbonate. On a surface of the substrate 101 on the side of the hologram recording medium layer 106 is formed a servo surface 102. In the servo surface 102, guide holes or pits for a focusing servo, a tracking servo, and a seeking servo are formed.

Also, FIG. 1 shows a state in which a servo laser beam 108 having a first wavelength is focused on the servo surface 102 by an object lens 310 and a recording/reproducing laser beam 109 having a second wavelength different from the first wavelength is focused on the dichroic mirror layer 104 by the object lens 310.

In the first embodiment, a red laser beam having a wavelength of about 650 nm or an infrared laser beam having a wavelength of about 780 nm can be used as the servo laser beam 108 having the first wavelength. Also, an available semiconductor laser beam or a blue-violet laser beam having a wavelength of 405 nm in terms of flexibility in the design of the hologram recording medium layer can be used as the recording/reproducing laser beam 109 having the second wavelength. Alternatively, a green laser beam having a wavelength of 532 nm may be used as the recording/reproducing laser beam 109.§

The transparent gap layers 103 and 105 transmit the servo laser beam 108 and the recording/reproducing laser beam 109. The gap layer 103 is formed by coating a material, such as UV resin, on the substrate 101 using, for example, a spin coating method. The gap layer 105 is formed by coating a material, such as UV resin, on the dichroic mirror layer 104 using, for example, a spin coating method. The gap layers 103 and 105 are for providing a gap between the hologram recording medium layer 106 and the servo surface. This gap is provided to adjust the size of a hologram to be generated by forming, in the hologram recording medium layer 106, a region having a predetermined size where the information beam and the reference beam interfere with each other.

The dichroic mirror layer 104 is formed by forming a wavelength separating filter on the gap layer 103 using a dielectric multi-layer coating (sputtering) method. The dichroic mirror layer 104 transmits the servo laser beam 108, but reflects the recording/reproducing laser beam 109. Therefore, the reference beam and the information beam of the recording/reproducing laser beam 109 interfere with each other in the hologram recording medium layer 106 such that information is recorded as holograms.

The hologram recording medium layer 106 is a layer where holograms are formed by the interference between the reference beam and the information beam of the recording/reproducing laser beam. The hologram recording medium layer 106 is formed of a recording medium, for example, photopolymer, that is sensitive to the recording/reproducing laser beam 109 having the second wavelength and is insensitive to the servo laser beam 108 having the first wavelength. Photopolymer is a photosensitive material using photopolymerization of a polymerizable compound (monomer). In general, photopolymer contains a monomer as a major component, a photopolymerization initiator, and a porous matrix taking charge of preventing a change in volume before and after performing recording. Also, the film thickness of the hologram recording medium is set to several hundreds of micrometers to obtain sufficient diffraction efficiency when signal reproduction is performed.

A hologram recording process on the hologram recording medium layer 106 is performed as follows. First, the information beam and the reference beam are superposed on the hologram recording medium, thereby forming interference fringes. At this time, the photopolymerization initiator of the photopolymer absorbs photons to be activated and thus the polymerization of the monomer in bright bands of the interference fringes is initiated and activated. The polymerization of the monomer progresses while consuming the monomer existing in the bright bands of the interference pattern. Then, the monomer moves from dark bands to the bright bands of interference fringes. As a result, a density difference occurs between the bright bands and the dark bands of the interference fringe pattern. Therefore, refractive-index modulation according to the intensity distribution of the interference fringe pattern is formed so as to perform hologram recording.

The servo laser beam 108 is focused on the servo surface 102 by the object lens 310. Also, the recording/reproducing laser beam 109 is focused on the dichroic mirror layer 104 by the object lens 310. To reduce load with respect to servo control, the object lens 310 is composed of a single lens whose both surfaces are aspheric to have a light weight. Also, the object lens 310 is optimized for the wavelength of the servo laser beam 108 and the wavelength of the recording/reproducing laser beam 109. Therefore, a hybrid object lens in which chromatic aberration has been corrected by engraving a diffraction grating 311 on its laser beam incident surface can be used. A zero-order beam having been diffracted by the diffraction grating 311 is used as the recording/reproducing laser beam 109. Also, plus and minus first-order beams having been diffracted by the diffraction grating 311 are used as the servo laser beam 108. This structure can be easily realized by diverting a technique which is currently being used for DVD/CD compatible lenses. Also, when the number of apertures of the object lens 310 differs in the servo laser beam 108 and the recording/reproducing laser beam 109, it is preferable to dispose an aperture restricting filter (not shown) composed of a wavelength selecting filter immediately before the object lens 310.

Next, a recording/reproducing apparatus for a holographic optical disc (optical disk recording apparatus) according to the first embodiment will be described. The recording/reproducing apparatus for an optical disc according to this embodiment performs recording/reproducing processes on the holographic optical disc having the structure shown in FIG. 1. A collinear hologram recording method in which an information beam and a reference beam are coaxially disposed is used as a hologram recording method. FIG. 2 is a schematic view illustrating the structure of an optical system of the recording/reproducing apparatus for a holographic optical disc according to the first embodiment.

As shown in FIG. 2, the recording/reproducing apparatus for an optical disc according to this embodiment includes an optical system including: a recording/reproducing semiconductor laser 301 (recording beam source) for emitting a recording/reproducing beam; a servo semiconductor laser 315 for emitting a servo laser beam; collimator lenses 302a and 302b; a diffraction grating 303 for an external resonator; a spatial light modulator 304; a spatial filter 305; polarization beam splitters 306a and 306b; a diffraction grating 316; a beam splitter 317; a dichroic prism 307; a quarter-wave plate 308; a mirror 309; the object lens 310 (focusing unit); focusing lenses 313a, 313b, and 313c; a cylindrical lens 318; photodetectors 319 and 320; and a CMOS-type solid-state image sensing device 314 (image sensing device). The recording/reproducing apparatus for an optical disc includes actuators 312 and a seeking actuator 340 as a portion of a servo mechanism. The actuators 312 are provided to perform focusing servo and tracking servo. The seeking actuator 340 is provided to seek the rotation of the holographic optical disc when a hologram is recorded.

The recording/reproducing optical system will now be described. The recording/reproducing semiconductor laser 301 emits, e.g., a blue-violet laser beam, which has a wavelength of 405 nm as the second wavelength, as the recording/reproducing laser beam. The linearly polarized laser beam emitted from the recording/reproducing semiconductor laser 301 is converted from a divergent beam into a parallel beam by the collimator lens 302a. The recording/reproducing semiconductor laser 301 may have a mode hopping property in which the oscillation wavelength of the laser is changed according to variation in the operation temperature or the injection current. Therefore, the mode hopping property is not preferable to the holographic optical disc having an extremely strict margin with respect to wavelength shift. For this reason, in this embodiment, the diffraction grating 303 for an external resonator is disposed immediately after the collimator lens 302. The beam diffracted by the diffraction grating 303 is returned to the laser device and a resonator is formed such that the beam is oscillated at a predetermined wavelength. In this embodiment, a simple and convenient Littrow-type resonator is used such that the first-order diffracted beam is returned to the laser device and the zero-order diffracted beam having a stabilized wavelength is extracted to be used. Alternatively, a Littman-type resonator other than the Littrow-type resonator may be used as the diffraction grating 303 for an external resonator. In the future, when a DFB (distributed-feed-back) laser having a long coherence distance with little wavelength shift comes into practical use, a DFB laser can be used as the semiconductor laser 301, which makes it unnecessary to provide the diffraction grating 303 for an external resonator.

The zero-order beam of the recording/reproducing laser beam 109 emitted from the diffraction grating 303 for an external resonator is incident on the spatial light modulator 304. The incident zero-order beam is subjected to optical intensity modulation by the spatial light modulator 304 so as to be converted into the reference beam and the information beam, which are emitted. In addition to a liquid crystal element, a digital micro-mirror device or a ferroelectric liquid crystal element having a high response speed of about, for example, several microseconds, can be used as the spatial light modulator 304.

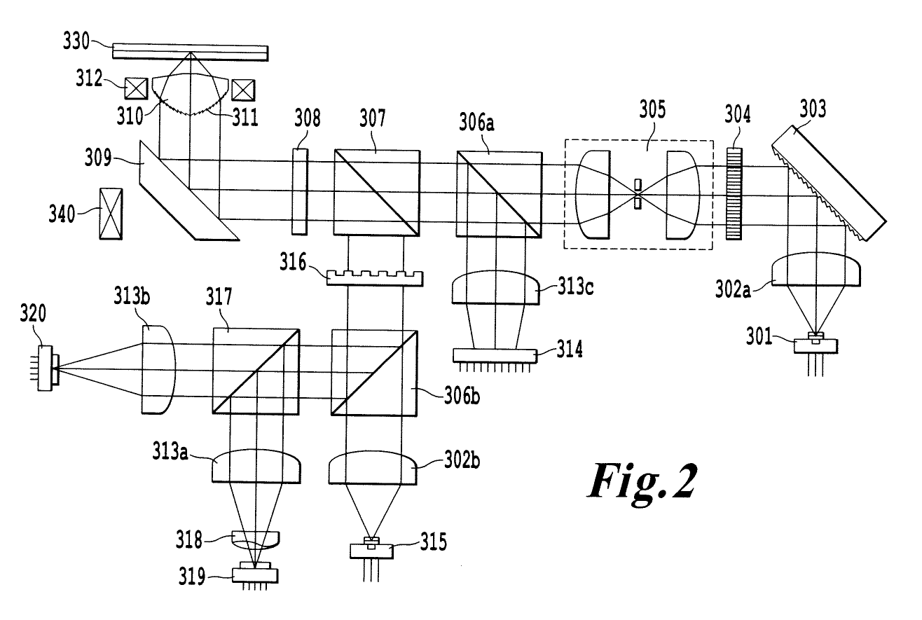

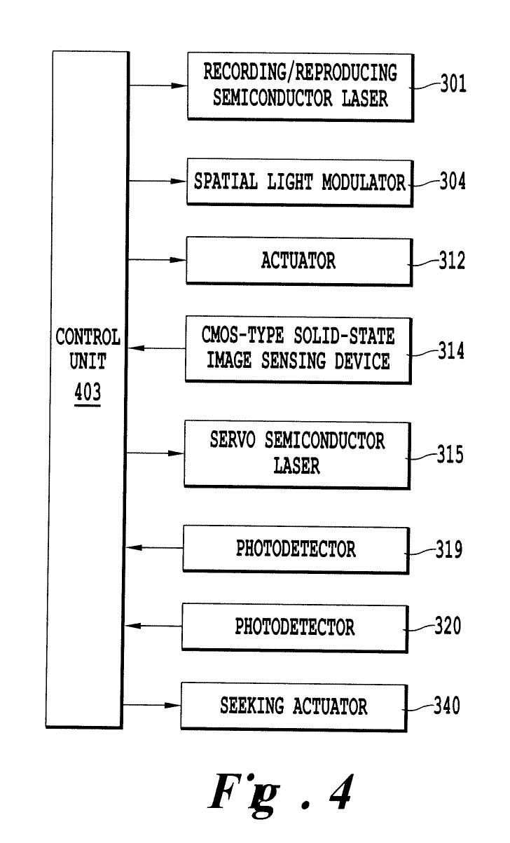

FIG. 3 is a view illustrating a modulation pattern of a reference beam 402 and an information beam 401 by the spatial light modulator 304.

The information beam 401 carries information on a binary pattern obtained by digitally encoding information to be recorded and incorporating an error correction code into the encoded digital code. The amount of data in an information beam region depends on the spatial light modulator, the number of pixels of a light-sensitive image sensing device, or an encoding method and is about 10 to 20 Kbits per frame. In this embodiment, the binary pattern composed of “0” and “1” is assumed as the information to be recorded. However, a multi-valued pattern can be used as the information to be recorded. In this case, it is possible to remarkably increase the amount of data per frame. The multi-valued pattern will be described in detail in a second embodiment.

The spatial filter 305 includes two lenses and a pinhole. The reference beam 402 and the information beam 401 emitted from the spatial light modulator 304 are incident on the spatial filter 305. The spatial filter 305 removes unnecessary high-order diffracted beams from the incident reference beam 402 and information beam 401 and emits the reference beam 402 and information beam 401 without the high-order diffracted beams.

The information beam 401 and the reference beam 402 without the unnecessary high-order diffracted beams emitted from the spatial filter 305 pass through the polarization beam splitter 306a and the dichroic prism 307, respectively. Then, the information beam 401 and the reference beam 402 are converted into a circularly polarized beam by the quarter-wave plate 308 and are then reflected by the mirror 309. As a result, the information beam 401 and the reference beam 402 are converged and radiated onto the holographic optical disc 330 by the object lens 310.

The information beam 401 and the reference beam 402 reflected by the holographic optical disc 330 travel through the object lens 310 in a direction opposite to the direction in which the information beam 401 and the reference beam 402 have been guided to the holographic optical disc, and are converted into linearly polarized beams perpendicular to linearly polarized beams which have been guided from the dichroic prism 307 to the quarter-wave plate 308, by the quarter-wave plate 308 (on an incident beam path). The reflected beams that have been converted into linearly polarized beams are reflected by the polarization beam splitter 306a and are then focused by the focusing lens 313c. After being focused, the reflected beams are received as a two-dimensional image by the CMOS-type solid-state image sensing device 314.

The servo optical system will be described. In this embodiment, focusing servo, tracking servo, and seeking servo are performed as servo control.

The servo semiconductor laser 315 emits, e.g., a red laser beam, which has a wavelength of 650 nm as the first wavelength, or an infrared laser beam, which has a wavelength of 780 nm as the first wavelength. The linearly polarized laser beam emitted from the servo semiconductor laser 315 is converted from a divergent beam into a parallel beam by the collimator lens 302b. Then, the parallel beam passes through the polarization beam splitter 306b. The parallel beam having passed through the polarization beam splitter 306b is incident on and diffracted by the diffraction grating 316 so as to be separated into three diffracted beams, that is, the zero-order beam and plus and minus first-order beams. Then, among the three diffracted beams, for example, it is possible that the plus first-order beam is used for the focusing servo and the tracking servo and the minus first-order beam is used for seeking the rotation of the holographic optical disc 330.

An ordinary diffraction grating having a rectangular shape in sectional view is used as the diffraction grating 316 and the depth of a trench of the grating is set such that the diffraction efficiency becomes a desired value. Also, in FIG. 2, for convenience of explanation, the three diffracted beams from the diffraction grating 316 are shown as one beam. When a polarization diffraction grating is used as the diffraction grating 316, it is possible to diffract only an incident beam path and thus to improve the usage efficiency of beams.

The three diffracted beams separated by the diffraction grating 316 are reflected by the dichroic prism 307, are circularly polarized by the quarter-wave plate 308, are reflected by the mirror 309, and are converged and radiated onto the servo surface 102 of the holographic optical disc 330 by the object lens 310. Here, the quarter-wave plate 308 is an element functioning as a quarter-wave plate at both the wavelength of the recording/reproducing laser beam and the wavelength of the servo laser beam. The servo laser beam (diffracted beam) reflected by the servo surface 102 of the holographic optical disc 330 travels through the object lens 310 in a direction opposite to the incident beam path. The reflected beam traveling in the opposite direction is converted into a linearly polarized beam perpendicular to the linearly polarized beam on the incident beam path by the quarter-wave plate 308. Then, the reflected light having been converted into the linearly polarized beam is reflected by the dichroic prism 307 and the polarization beam splitter 306b. The reflected beam having been reflected by the polarization beam splitter 306b is separated by the beam splitter 317 into a beam reflected by the beam splitter 317 and a beam passing through the beam splitter 317 at a predetermined light amount ratio.

The beam reflected by the beam splitter 317 is converted from a parallel beam into a convergent beam by the focusing lens 313a. The beam having been converted into the convergent beam is refracted by the cylindrical lens 318 as it passes through the cylindrical lens 318, and is then focused onto the photodetector 319. The photodetector 319 converts the optical power of the focused beam into an electrical signal. The focusing servo is performed by a beam spot focused onto the photodetector 319 such that the actuator 312 is driven.

Meanwhile, the transmission beam having passed through the beam splitter 317 is converted from a parallel beam into a convergent beam by the focusing lens 313b and is then focused onto the photodetector 320. The tracking servo is performed by a beam spot of the transmission beam focused onto the photodetector 320 such that the actuator 312 is driven. Further, the seeking servo is performed by the beam spot of the reflected beam focused onto the photodetector 320 such that the seeking actuator 340 is driven.

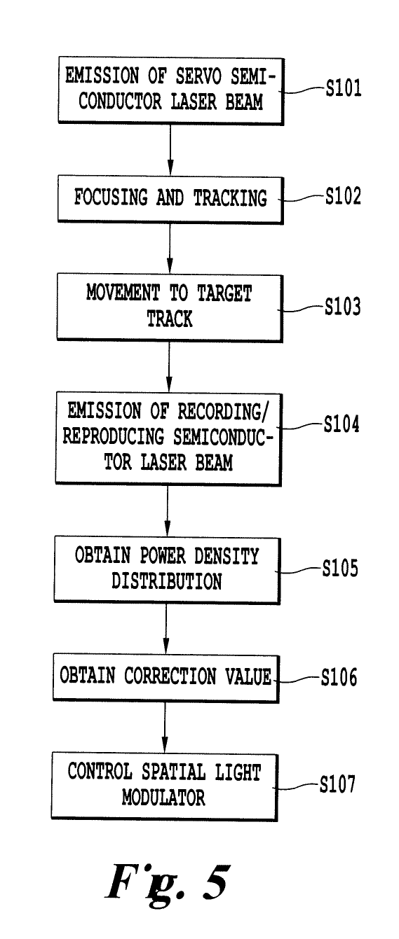

FIG. 4 is a view illustrating the structure of a control system of the recording/reproducing apparatus for a holographic optical disc according to the first embodiment. As shown in FIG. 4, as a control system, a control unit 403 is connected to the recording/reproducing semiconductor laser 301, the spatial light modulator 304, the actuators 312, the servo semiconductor laser 315 and the seeking actuator 340 so as to be capable of transmitting control signals to them. Also, the control unit is connected to the CMOS-type solid-state image sensing device 314 and the photodetectors 319 and 320 so as to be capable of receiving detected signals from them.

FIG. 5 is a view illustrating a control method when the recording/reproducing apparatus for a holographic optical disc records information on a holographic optical disc. The control method is performed by transmission of a control signal by the control unit 403 to the recording semiconductor laser 301, the spatial light modulator 305, the actuators 302, the servo semiconductor laser 315, and the seeking actuator 340.

First, the control unit 403 transmits a control signal for starting the emission of the servo semiconductor laser 315 to the servo semiconductor laser 315 (S101). The laser beam emitted from the servo semiconductor laser 315 is converged and radiated onto the servo surface 102 of the holographic optical disc 330, as described above. Then, the laser beam that has been converged and radiated onto the servo surface 102 of the holographic optical disc 330 is reflected by the servo surface 102 and focused on the photodetectors 319 and 320, as described above.

The control unit 403 receives detection signals, transmitted from the photodetectors 319 and 320, of the laser beam having been reflected by the servo surface 102. Also, the control unit 403 outputs a control signal to the actuators 312 to perform focusing servo and tracking servo (S102).

Subsequently, the control unit 403 moves the laser beam emitted from the servo semiconductor laser 315 to a target track by controlling a moving unit (not shown), such as a carriage, to radiate the laser beam onto the target track (S103). Here, the target track is a track at a position where the laser beam emitted from the recording/reproducing semiconductor laser 301 is not radiated on the hologram recording medium layer 106 of the holographic optical disc 330, but is radiated on the dichroic mirror layer 104.

After moving the laser beam to the target track, the control unit 403 transmits the control signal for starting the emission of the recording/reproducing semiconductor laser 301 to the recording/reproducing semiconductor laser 301 (S104). The laser beam emitted from the recording/reproducing semiconductor laser 301 is converged and radiated onto the dichroic mirror layer 104 of the holographic optical disc 330, as described above. Then, the laser beam that has been converged and radiated onto the dichroic mirror layer 104 of the holographic optical disc 330 is reflected by the dichroic mirror layer 104 and is focused on the CMOS-type solid-state image sensing device 314, as described above.

The control unit 403 receives a detection signal, transmitted from the CMOS-type solid-state image sensing device 314, of the laser beam having been reflected by the dichroic mirror layer 104. Also, the control unit 403 obtains the power density distribution (intensity distribution) of the recording/reproducing semiconductor laser 301 (S105). Here, the detection signal transmitted from the CMOS-type solid-state image sensing device 314 is a signal representing the intensity distribution of the laser beam focused on the CMOS-type solid-state image sensing device 314. The power density distribution of the recording/reproducing semiconductor laser 301 can be obtained from the ratio between the intensity of the beam received by the CMOS-type solid-state image sensing device 314 for each pixel and a modulation condition of the spatial light modulator 304 for each pixel.

Therefore, when the emission of the recording/reproducing semiconductor laser 301 starts, preferably, the control unit 403 sets the modulation conditions of the spatial light modulator 304 for individual pixels to the same condition. Simultaneously, it is preferable to set the light receiving conditions of the CMOS-type solid-state image sensing device 314 for the individual pixels to substantially the same condition. In this case, the intensity of the beam received by the CMOS-type solid-state image sensing device 314 of each pixel can be considered as the power density distribution of the recording/reproducing semiconductor laser 301. Here, the beam intensity is a value obtained by integrating the power density with respect to an area.

Subsequently, the control unit 403 obtains a correction value of the spatial light modulator 304 according to the obtained power density distribution (S106). A method of obtaining the correction value will be described below.

The control unit 403 controls the spatial light modulator 304 on the basis of the obtained correction value when a hologram is recorded on the holographic optical disc 330 (S107).

More specifically, the control unit 403 controls the spatial light modulator 304 to reduce, on the basis of the correction value, the light amount of each of the bright pixels among the individual pixels of the beam carrying the information on the binary pattern of the information beam 401. That is, for example, when the correction value is set to a coefficient within a range of 0 to 1, the control unit 403 controls the spatial light modulator 304 such that the light amount of a bright pixel becomes the product of the correction value and the light amount before correction. Similarly, if necessary, the control unit 403 controls the spatial light modulator 304 to reduce, on the basis of the correction value, the light amount of each of the dark pixels among the individual pixels of the beam carrying the information on the binary pattern of the information beam 401.

Here, the light amount (radiation amount) is a value obtained by integrating the power density with respect to time. That is, control is performed such that the light amount of each pixel becomes a predetermined light amount. For example, when a liquid crystal element is used as the spatial light modulator 304, the transmission coefficient of the bright pixel with respect to the laser beam emitted from the recording/reproducing semiconductor laser 301 is controlled. Also, for example, when a digital micro-mirror device is used as the spatial light modulator 304, the time when the laser beam emitted from the recording/reproducing semiconductor laser 301 is reflected from the spatial filter 305 toward the anterior optical system is controlled.

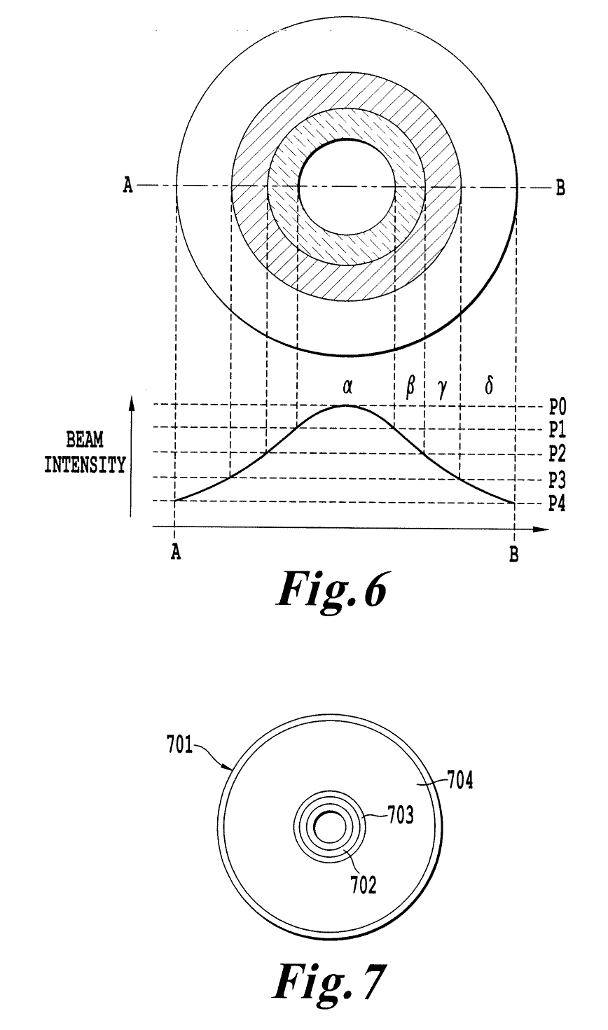

The method of obtaining the correction value will now be described. The power density distribution obtained by the control unit 403 generally becomes substantially the Gaussian distribution as shown in, for example, FIG. 6. In this embodiment, an example in which the power density is divided into five levels of P0 to P4 and the spatial light modulator 304 is controlled by applying any of four correction values to every pixel will be described. Here, an area from A to B shown in FIG. 6 is an arbitrary area. That is, the area is, for example, an area obtained by adding a margin considering, for example, the assembly accuracy of the optical system to the area of the light beam of the recording/reproducing semiconductor laser 301 converted to the information beam 401 by using the spatial light modulator 304.

The highest power density of the power densities obtained by the control unit 403 is set to P0. That is, when the power density distribution is substantially a general Gaussian distribution as described above, the power density at the center is set to P0. Meanwhile, the lowest power density of the power densities obtained by the control unit 403 is set to P4. That is, when the power density distribution is substantially a general Gaussian distribution, the power density at the outer skirt portion is set to P4. The power density range from P0 to P4 is divided into four equal parts. For example, the area from A to B is divided into four areas α, β, γ, and δ according to the divided power density distribution ranges.

Then, the correction value of the area 6 where the power density is lowest and which is a reference is set to 1. In each of the three remaining areas, a correction value is obtained such that the highest power density in the corresponding area becomes close to the lowest power density in the area δ. At this time, ideally, a correction value is obtained such that the highest power density in the corresponding area becomes the same as the lowest power density in the area δ. More specifically, it is possible that the correction value of the area γ is set to P4/P3, the correction value of the area β is set to P4/P2, and the correction value of the area α is set to P4/P1.

When the intensity distribution of the light beam emitted from the recording/reproducing semiconductor laser 301 in the diametric direction is not substantially a Gaussian distribution, when there is an individual difference in the recording/reproducing semiconductor laser 301, or when there is an assembly variation of the optical system including the recording/reproducing semiconductor laser 301 or the object lens 310, the optical disk recording apparatus and method can reduce the difference in the amount of information beam 401 to be recorded among the bright pixels, occasionally, among the bright pixels and the dark pixels. That is, when the information beam 401 and the reference beam 402 interfere with each other, it is possible to reduce the effect on interference contrast.

Since the intensity distribution of the light beam emitted from the recording/reproducing semiconductor laser 301 in the diametric direction can be detected without requiring a separate adjusting sensor, etc., it is possible to simplify the process of manufacturing the optical disk recording apparatus.

The processes S101 to S106 are performed before a hologram is recorded on the holographic optical disc 330 as described above. However, it is not always necessary to perform the processes S101 to 106 immediately before a hologram is recorded on the holographic optical disc 330. Further, it is not always necessary to perform the processes S101 to 106 whenever a hologram is recorded on the holographic optical disc 330. For example, it is possible to perform the processes S101 to S106 at predetermined time intervals or whenever a power supply of the optical disk recording apparatus starts. Also, when the optical disk recording apparatus is manufactured, it is possible to perform the processes S101 to S106 once at the time of adjustment before shipment.

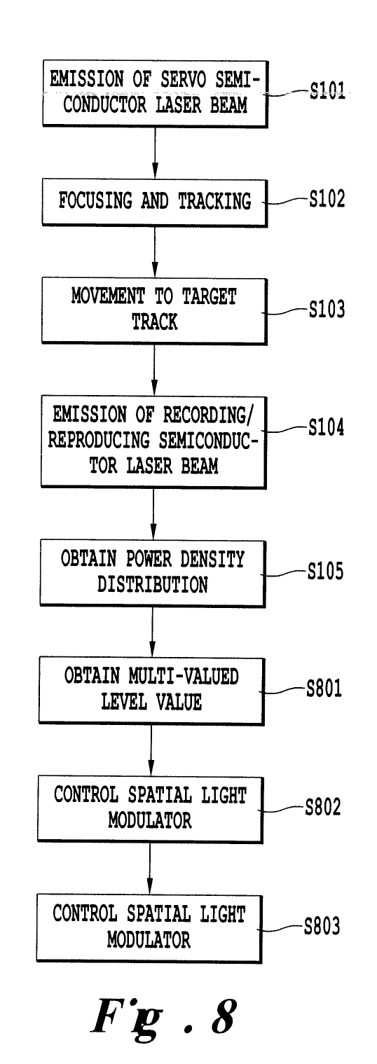

FIG. 7 is a view illustrating a holographic optical disc serving as an optical disk according to a second embodiment of the invention. In this embodiment, the same components as those in the optical disk recording apparatus and method and the optical disk used for the optical disk recording apparatus and method according to the first embodiment of the invention are denoted by the same reference numerals, and a description thereof will be omitted.

A holographic optical disc 701 is provided with a calibration area 702, a multi-valued information area 703, and a data area 704.

The calibration area 702 will now be described. In the calibration area 702, a dichroic mirror layer 104 and a servo surface 102 are provided in a depth direction of the holographic optical disc 701. The calibration area 702 is an area where the target track in the process S103 of the first embodiment is provided.

The multi-valued information area 703 will now be described. In the multi-valued information area 703, a dichroic mirror layer 104, a hologram recording medium layer 106, and a servo surface 102 are provided in the depth direction of the holographic optical disc 701. The hologram recording medium layer 106 of the multi-valued information area 703 is a layer where a hologram is formed by the interference between the information beam 401 and the reference beam 402. The information beam 401 of a hologram to be recorded in the multi-valued information area 703 is a beam carrying information on a binary pattern obtained by digitally encoding information to be recorded and incorporating an error correction code into the encoded digital code.

The data area 704 will now be described. In the data area 704, the dichroic mirror layer 104, the hologram recording medium layer 106, and the servo surface 102 are provided in the depth direction of the holographic optical disc 701. The hologram recording medium layer 106 of the data area 704 is a layer where a hologram is formed by the interference between the information beam 401 and the reference beam 402. The information beam 401 of a hologram to be recorded in the multi-valued information area 703 is a beam carrying information on a multi-valued pattern obtained by digitally encoding information to be recorded and incorporating an error correction code into the encoded digital code or information on a combination of a binary pattern and a multi-valued pattern.

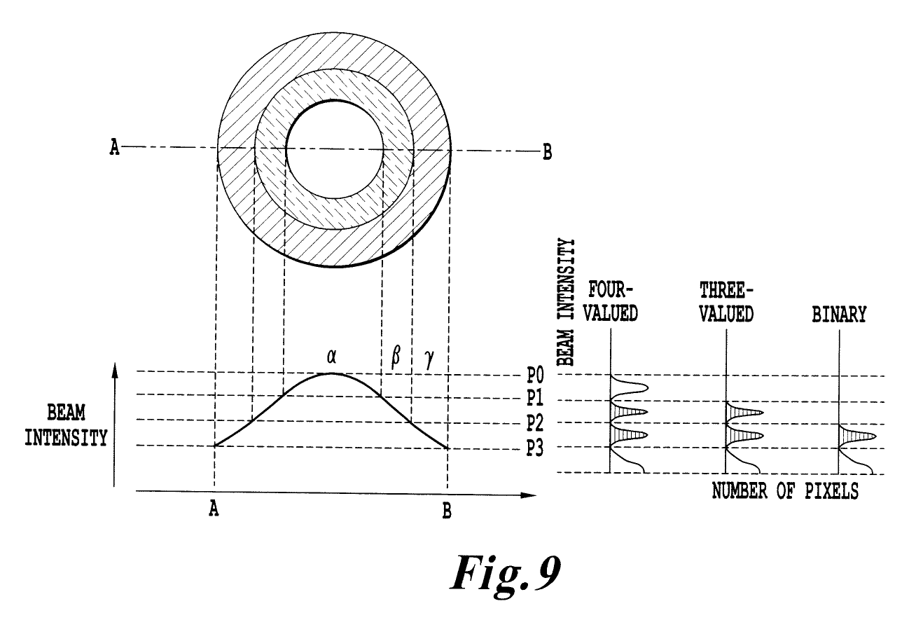

FIG. 8 is a view illustrating a control method when a recording/reproducing apparatus for a holographic optical disc according to the second embodiment performs recording on the holographic optical disc. This control method is performed by controlling signal transmission of control signals from the control unit 403 to the recording/reproducing semiconductor laser 301, the spatial light modulator 304, the actuators 302, the servo semiconductor laser 315, and the seeking actuator 340.

In the embodiment of FIG. 8 operations S101-S105 as in the embodiment of FIG. 5 are initially executed. Then, the control unit 403 obtains multi-valued level values with respect to the individual pixels of the spatial light modulator 304 according to the obtained power density distribution (S801). A method of obtaining the multi-valued level values will be described below in detail. Here, the multi-valued level values are values each representing the amount of information carried to the corresponding pixel.

The binary pattern is used when a digital signal with respect to one pixel is composed of one bit. In this case, it is possible that, when the bit value is 1, the corresponding pixel is set to a bright pixel, and when the bit value is 0, the corresponding pixel is set to a dark pixel. A four-valued pattern is used when a digital signal with respect to one pixel is composed of two bits. In this case, for example, it is possible that, when the value of the two bits is 11, 00, 01, and 10, the corresponding pixel is set to a bright pixel, a dark pixel, a first intermediate pixel that is brighter than a dark pixel and darker than a bright pixel, and a second intermediate pixel that is brighter than a first intermediate pixel and darker than a bright pixel, respectively.

The control unit 403 controls the spatial light modulator 304 on the basis of the obtained multi-valued level values to record the hologram in the multi-valued information area 703 of the holographic optical disc 701 (S802). In the multi-valued information area 703, multi-valued information with respect to the obtained multi-valued level values is recorded.

The control unit 403 controls the spatial light modulator 304 on the basis of the obtained multi-valued level values to record the hologram in the data area 704 of the holographic optical disc 701 (S803). In the data area 704, the information to be recorded or information (data), on which, for example, encoding has been performed as described above, to be recorded is recorded.

Specifically, the control unit 403 controls the spatial light modulator 304 to reduce, on the basis of the multi-valued level values, the amount of beams of individual pixels of the beam carrying the information on the multi-valued pattern of the information beam 401. For example, when the multi-valued level value is set to a coefficient within a range of 0 to 1, the control unit 403 controls the spatial light modulator 304 such that the amount of light of each pixel becomes the product of the multi-valued level value and the amount of light when the multi-valued level value is set to 1.

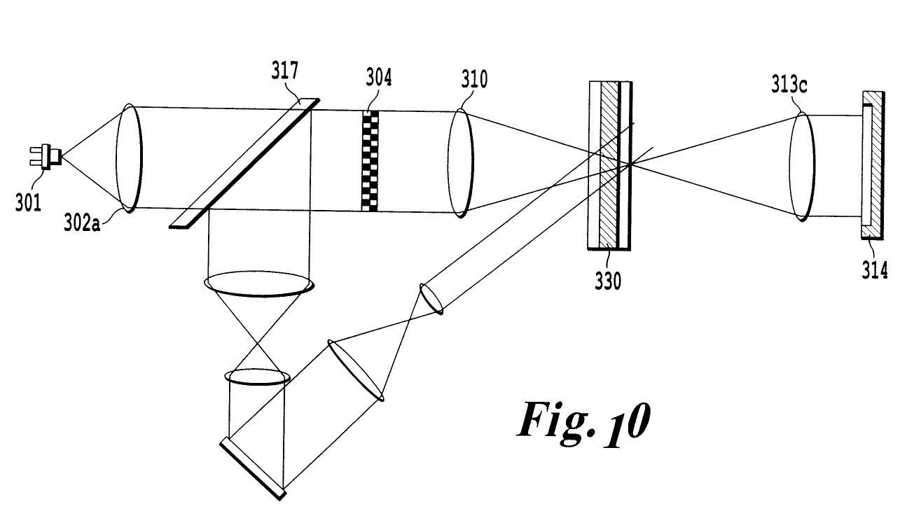

The method of obtaining the multi-valued level value will now be described. The power density distribution obtained by the control unit 403 generally becomes substantially a Gaussian distribution as shown in, for example, FIG. 9. In this embodiment, an example in which the power density is divided into four levels of P0 to P3 and the spatial light modulator 304 is controlled by applying any of four multi-valued level values to every pixel will be described. Here, an area from A to B shown in FIG. 9 is an arbitrary area. The area from A to B is an area obtained by adding a margin considering, for example, the assembly accuracy of the optical system to the area of the light beam of the recording/reproducing semiconductor laser 301 converted to the information beam 401 by using the spatial light modulator 304.

The highest power density of the power densities obtained by the control unit 403 is set to P0. For example, when the power density distribution is substantially a general Gaussian distribution as described above, the power density at the center is set to P0. Meanwhile, the lowest power density of the power densities obtained by the control unit 403 is set to P3. For example, when the power density distribution is substantially a general Gaussian distribution as described above, the power density at the outer skirt portion is set to P3. The power density range from P0 to P3 is divided into three equal parts. For example, the area from A to B is divided into three areas α, β, and γ according to the divided power density distribution ranges.

Then, the area γ where the power density is lowest and which is a reference is set to an area to carry a binary pattern using bright pixels and dark pixels. The area β where the power density is lowest next to the area γ is set to an area to carry a three-valued pattern using bright pixels, dark pixels, and first intermediate pixels. The area α where the power density is lowest next to the area β is set to an area to carry a four-valued pattern using bright pixels, dark pixels, first intermediate pixels, and second intermediate pixels. In this embodiment, the area α where the power density is lowest next to the area β is an area where the power density is highest.

In the area γ to carry the binary pattern, for example, the multi-valued level value of a dark pixel is set to 0 and the multi-valued level value of a bright pixel is set to 1. In the area β to carry the three-valued pattern, the multi-valued level value of a dark pixel is set to 0, the multi-valued level value of a bright pixel is set to 1, and the multi-valued level value of a first intermediate pixel is set to ½. In the area α to carry the four-valued pattern, the multi-valued level value of a dark pixel is set to 0, the multi-valued level value of a bright pixel is set to 1, the multi-valued level value of a first intermediate pixel is set to ⅓, and the multi-valued level value of a second intermediate pixel is set to ⅔.

That is, when “I” is set to an integer within a range of 0 to (X−1), the multi-valued level value of an I-th intermediate pixel among the individual pixels of an area to carry an X-valued pattern becomes I/(X−1). Here, a dark pixel corresponds to a 0-th intermediate pixel and thus the multi-valued level value of the dark pixel is 0. Also, a bright pixel corresponds to an I-th intermediate pixel and thus the multi-valued level value of the bright pixel is 1.

The multi-valued information will now be described in detail. As described above, the multi-valued information is recorded as a hologram on the multi-valued information area 703 of the holographic optical disc 701. The hologram related to the multi-valued information is recorded by the interference between the reference beam 402 and the information beam 401 carrying the information on the binary pattern. The multi-valued information is information representing the relationship between the carried X-valued pattern and the pixels of the information beam 401.

For example, with respect to the area γ to carry the binary pattern, the multi-valued information is information containing the position of the area γ in the information beam 401 and the value of “X” of the X-valued pattern carried to the area γ, that is, “2” in this embodiment. If necessary, the multi-valued information contains the relationship between I-th intermediate pixels and the multi-valued level values thereof, that is, the relationship in which the multi-valued level value of a bright pixel is “1” and the multi-valued level value of a dark pixel is “0” in this embodiment.

For example, with respect to the area cc to carry the four-valued pattern, the multi-valued information is information containing the position of the area α in the information beam 401 and the value of “X” of the X-valued pattern carried to the area α, that is, “4” in this embodiment. If necessary, the multi-valued information contains the relationship between I-th intermediate pixels and the multi-valued level values thereof, that is, the relationship in which the multi-valued level value of a bright pixel is “1”, the multi-valued level value of a dark pixel is “0”, the multi-valued level value of a first intermediate pixel is “⅓”, and the multi-valued level value of a second intermediate pixel is “⅔” in this embodiment.

When the intensity distribution of the light beam emitted from the recording/reproducing semiconductor laser 301 in the diametric direction is not substantially a Gaussian distribution, when there is an individual difference in the recording/reproducing semiconductor laser 301, or when there is an assembly variation of the optical system including the recording/reproducing semiconductor laser 301 or the object lens 310, the optical disk recording apparatus and method can carry a multi-valued pattern having levels according to the intensity distribution of the light beam in the diametric direction. That is, when the information beam 401 and the reference beam 402 interfere with each other, it is possible to reduce the effect on interference contrast.

Further, since the multi-valued pattern can be effectively carried, it is possible to increase the amount of information capable of being carried. In addition, it is possible to determine the amount of information capable of being carried.

Since the intensity distribution of the light beam emitted from the recording/reproducing semiconductor laser 301 in the diametric direction can be detected without requiring a separate adjusting sensor, etc., it is possible to simplify the process of manufacturing the optical disk recording apparatus.

Further, in such an optical disc binary pattern information is recorded with respect to the multi-valued level value, so that the optical disc recording apparatus can readily check the multi-valued level value corresponding to each pixel.

The processes S101 to S106 are performed before a hologram is recorded on the holographic optical disc 330, as described above. However, it is not always necessary to perform the processes S101 to 106 immediately before a hologram is recorded on the holographic optical disc 330. Further, it is not always necessary to perform the processes S101 to S801 whenever a hologram is recorded on the holographic optical disc 330. For example, it is possible to perform the processes S101 to S801 at predetermined time intervals or whenever a power supply of the optical disk recording apparatus starts. Also, when the optical disk recording apparatus is manufactured, it is possible to perform the processes S101 to S801 only once at the time of adjustment before shipment.

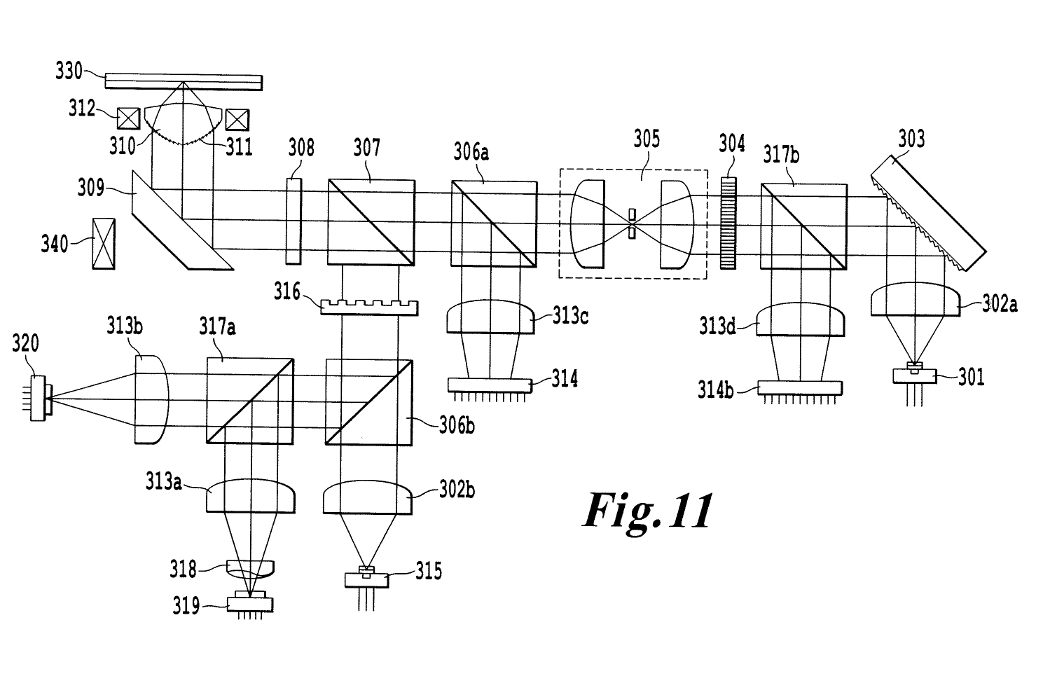

The optical disk recording apparatus, the method of controlling the optical disk recording apparatus, and the optical information recording disc used therefore according to the invention are not limited to the above-mentioned embodiments and can be used in a recording/reproducing apparatus for an optical disc using a recording method other than the collinear hologram recording method. For example, they can be used in a recording/reproducing apparatus using a two-beam interference hologram recording method as shown in FIG. 10, in which corresponding elements as in the previous embodiments are given corresponding reference numbers.

Further, in the first embodiment and the second embodiment, an example in which one CMOS-type solid-state image sensing device 314 is used has been described. However, as shown in FIG. 11, a beam splitter 317b, a focusing lens 313d, and a CMOS-type solid-state image sensing device 314b may be further provided between the diffraction grating 303 for an external resonator and the spatial light modulator 304.

The 0-th beam of the recording/reproducing laser beam emitted from the diffraction grating 303 for an external resonator is incident on the beam splitter 317b before being incident on the spatial light modulator 304. The 0-th beam of the recording/reproducing laser beam incident on the beam splitter 317b is divided into a beam reflected by the beam splitter 317b and a beam passing through the beam splitter 317b at a predetermined light amount ratio.

The beam having passed through the beam splitter 317b is incident on the spatial light modulator 304 and the beam having been reflected by the beam splitter 317b is incident on the focusing lens 313d. The beam incident on the focusing lens 313d is focused on the CMOS-type solid-state image sensing device 314b and the detection signal is transmitted to the control unit 403 to obtain the power density distribution.

The optical disk recording apparatus and the method of controlling the optical disk recording apparatus can obtain the power density distribution in real time when information recording/reproducing is performed. Therefore, even when the intensity distribution of the light beam emitted from the recording/reproducing semiconductor laser 301 in the diametric direction is changed, it is possible to reduce the difference in the amount of information beam 401 to be recorded among the bright pixels, occasionally, among the bright pixels and the dark pixels.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical disc recording apparatus comprising:
a recording beam source configured to emit a recording radiation beam;
a spatial light modulator configured to modulate the recording radiation beam into an information beam and a reference beam for a plurality of pixels;
a focusing unit configured to focus the recording radiation beam, the reference beam, or the information beam and the reference beam, onto an information recording layer;
an image sensing device configured to detect optical intensity distribution of the recording radiation beam or the information beam; and
a control unit configured to control the spatial light modulator,
wherein the optical disc recording apparatus is configured to record information as a hologram on the information recording layer formed in an optical disc by interference fringes generated by interference between the information beam carrying the information and the reference beam, and
wherein the control unit is further configured to obtain a value representing an integrated intensity distribution detected by the image sensing device across at least some of the plurality of pixels, and to control the spatial light modulator such that information related to the value is carried by the information beam.

2. The optical disc recording apparatus according to claim 1,
wherein the control unit is further configured to control the spatial light modulator to reduce the amount of light radiated to the at least some of the pixels based on the value.

3. The optical disc recording apparatus according to claim 2,
wherein the control unit is further configured to divide at least a portion of the spatial light modulator into a predetermined number of areas based on the intensity distribution detected by the image sensing device, and to obtain the value such that the beam intensity in each of areas except for an area where the beam intensity detected by the image sensing device is lowest becomes closer to the beam intensity in the area where the beam intensity detected by the image sensing device is lowest.

4. The optical disc recording apparatus according to claim 3,
wherein the predetermined number of areas is 4.

5. The optical disc recording apparatus according to claim 4,
wherein the value is a ratio A/B,
in which A is a lowest beam intensity in the area where the detected beam intensity is lowest among the areas, and B is a lowest beam intensity in an area to be controlled based on the value.

6. An optical disc recording method comprising:
emitting a recording radiation beam;
modulating, by a spatial modulator, the recording radiation beam into an information beam and a reference beam for a plurality of pixels;
focusing the recording radiation beam, the reference beam, or the information beam and the reference beam, onto an information recording layer to record information;
detecting optical intensity distribution of the recording radiation beam or the information beam; and
controlling the modulating, including
obtaining a value representing an integrated intensity distribution across at least some of the plurality of pixels, and
controlling the modulating such that information related to the value is carried by the information beam; and
recording information as a hologram on the information recording layer formed in an optical disc by interference fringes generated by interference between the information beam carrying the information and the reference beam.

7. The optical disc recording method according to claim 6,
wherein the controlling further reduces the amount of light radiated to the at least some of the pixels based on the value.

8. The optical disc recording method according to claim 7,
wherein the controlling further divides at least a portion of the spatial light modulator into a predetermined number of areas based on the intensity distribution, and obtains the value such that the beam intensity in each of areas except for an area where the beam intensity is lowest becomes closer to the beam intensity in the area where the beam intensity is lowest.

9. The optical disc recording method according to claim 8,
wherein the predetermined number of areas is 4.

10. The optical disc recording method according to claim 9,
wherein the value is a ratio A/B,
in which A is a lowest beam intensity in the area where the detected beam intensity is lowest among the areas, and B is a lowest beam intensity in an area to be controlled based on the value.

11. A controlling method of an optical disc recording apparatus including a recording beam source configured to emit a recording radiation beam, a spatial light modulator configured to modulate the recording radiation beam into the information beam and the reference beam for a plurality of pixels, a focusing unit configured to focus the recording radiation beam, the reference beam, or the information beam and the reference beam, onto the information recording layer, and an image sensing device configured to detect the optical intensity distribution of the recording radiation beam or the information beam, the method comprising:
changing a value representing an integrated intensity distribution across at least some of the plurality of pixels carried by the information beam and to be radiated to an information recording layer; and
recording the information as a hologram on the information recording layer formed in an optical disc by interference fringes generated by interference between the information beam carrying the information, and a reference beam.

12. The controlling method of an optical disc recording apparatus according to claim 11, further comprising:
reducing the amount of beam radiated to the at least some of the pixels based on the value.

13. The controlling method of an optical disc recording apparatus according to claim 11, further comprising:
dividing at least a portion of the spatial light modulator into a predetermined number of areas based on the intensity distribution; and
obtaining the value such that the beam intensity in each of the areas except for an area where the beam intensity detected by the image sensing device is lowest becomes closer to the beam intensity in the area where the beam intensity detected by the image sensing device is lowest.

14. The controlling method of an optical disc recording apparatus according to claim 13,
wherein the predetermined number of areas is 4.

15. The controlling method of an optical disc recording apparatus according to claim 14,
wherein the value is a ratio A/B,
in which A is a lowest beam intensity in the area where the detected beam intensity is lowest among the areas, and B is a lowest beam intensity in an area to be controlled based on the value.

16. An optical disc for the optical disc recording apparatus comprising:
a data area;
a multi-valued information area for recording information on a binary pattern related to a value representing an amount of information carried by at least some of pixels by an information beam; and
information recorded on an information recording layer by interference fringes generated by interference between the information beam carrying the information and a reference beam.

17. The optical disc according to claim 16, further comprising:
a calibration area for obtaining the value according to a reflected beam.
